(19) United States
(12) Patent Application Publication
(10) Pub. No.: US 2013/0316577 A1
(43) Pub. Date: Nov. 28, 2013

(54) COAXIAL CABLE CONNECTOR STRUCTURE WITH CONTACT CONTINUITY

(71) Applicant: SHOU-YING WANG, TAIPEI CITY (TW)

(72) Inventor: SHOU-YING WANG, TAIPEI CITY (TW)

(21) Appl. No.: 13/480,536

(22) Filed: May 25, 2012

(51) Int. Cl. H01R 9/05

(52) U.S. Cl. 439/583

(57) ABSTRACT

A coaxial cable connector structure with contact continuity includes a sleeve and a ring-shaped screw cap provided at a front end of the sleeve. The sleeve has an inner tube provided therein for connecting a coaxial cable. An inner wall of the ring-shaped screw cap and an outer wall of the inner tube in the sleeve have a ring-shaped conducting member provided there-between, thereby forming electrical connection between the ring-shaped screw cap and the inner tube.

### BACKGROUND OF THE INVENTION

1. Field of Invention

The present invention relates to a coaxial cable connector structure, and in particular, to a coaxial cable connector structure with contact continuity, which has a simple structure and effectively maintains the function of signal transmission.

2. Related Art

A coaxial cable is a signal transmission line that is already widely applied in a television system and a network system. The coaxial cable is locked, by a coaxial cable connector provided at an end thereof, to a corresponding coaxial cable connection socket of an audio-visual device or a network device. A common F-type coaxial cable connector is taken as an example, which uses a sleeve to connect a coaxial cable, where the sleeve has a swivel ring-shaped screw cap provided at a front end thereof, and the ring-shaped screw cap has an inner thread provided on an inner surface thereof and a hexagonal outer wall provided on an outer surface thereof, so that the ring-shaped screw cap can be turned and locked by fingers or a clamping tool.

When the above coaxial cable connector is locked to the coaxial cable connection socket in a manually rotating manner, the ring-shaped screw cap needs to be turned repeatedly to rotate the coaxial cable connector completely into the coaxial cable connection socket, so as to ensure electrical connection and signal transmission of the coaxial cable. However, since the external contact area of the ring-shaped screw cap is small, the ring-shaped screw cap cannot be effectively turned by the force of the fingers, making the action of manually tightening the ring-shaped screw cap time-consuming and energy-consuming. Besides, since the coaxial cable connection socket is mostly provided on the rear of the above device, when the device is provided in a narrow space, a user must firstly move out the device and then lock the coaxial cable connector completely, which is rather inconvenient.

Consequently, in order to improve the above disadvantages, enable the coaxial cable connector structure to transmit a signal before it is completely locked to the coaxial cable connection socket, and enhance the convenience of use, the present invention is proposed by the inventor with years of accumulated experience and continuous research and improvement.

### SUMMARY OF THE INVENTION

The main objective of the present invention is to provide a coaxial cable connector structure with contact continuity, which has a simple structure and effectively maintains the function of signal transmission.

To achieve the above objective, the coaxial cable connector structure with contact continuity provided by the present invention includes a sleeve and a ring-shaped screw cap provided at a front end of the sleeve. The sleeve has an inner tube provided therein for connecting a coaxial cable. An inner wall of the ring-shaped screw cap and an outer wall of the inner tube in the sleeve have a ring-shaped conducting member provided there-between, thereby forming electrical connection between the ring-shaped screw cap and the inner tube.

In the implementation, the conducting member includes a ring-shaped body. The ring-shaped body is provided with a plurality of arc-shaped or non-arc-shaped contact pieces.

In the implementation, an inner surface of the ring-shaped screw cap has an inner thread for combining a connection socket with an outer thread.

The present invention will become more fully understood by reference to the following detailed description thereof when read in conjunction with the attached drawings.

### BRIEF DESCRIPTION OF THE DRAWINGS

The present invention will become more fully understood from the detailed description given herein below for illustration only, and thus are not limitative of the present invention, and wherein:

FIG. 1 is a schematic combined diagram of an embodiment of the present invention;

FIG. 2 is a schematic partial enlarged diagram of FIG. 1;

FIG. 3 is a schematic outside diagram of a conducting member in an embodiment of the present invention; and

FIG. 4 is a side view of a conducting member in an embodiment of the present invention.

### DETAILED DESCRIPTION OF THE PRESENT INVENTION

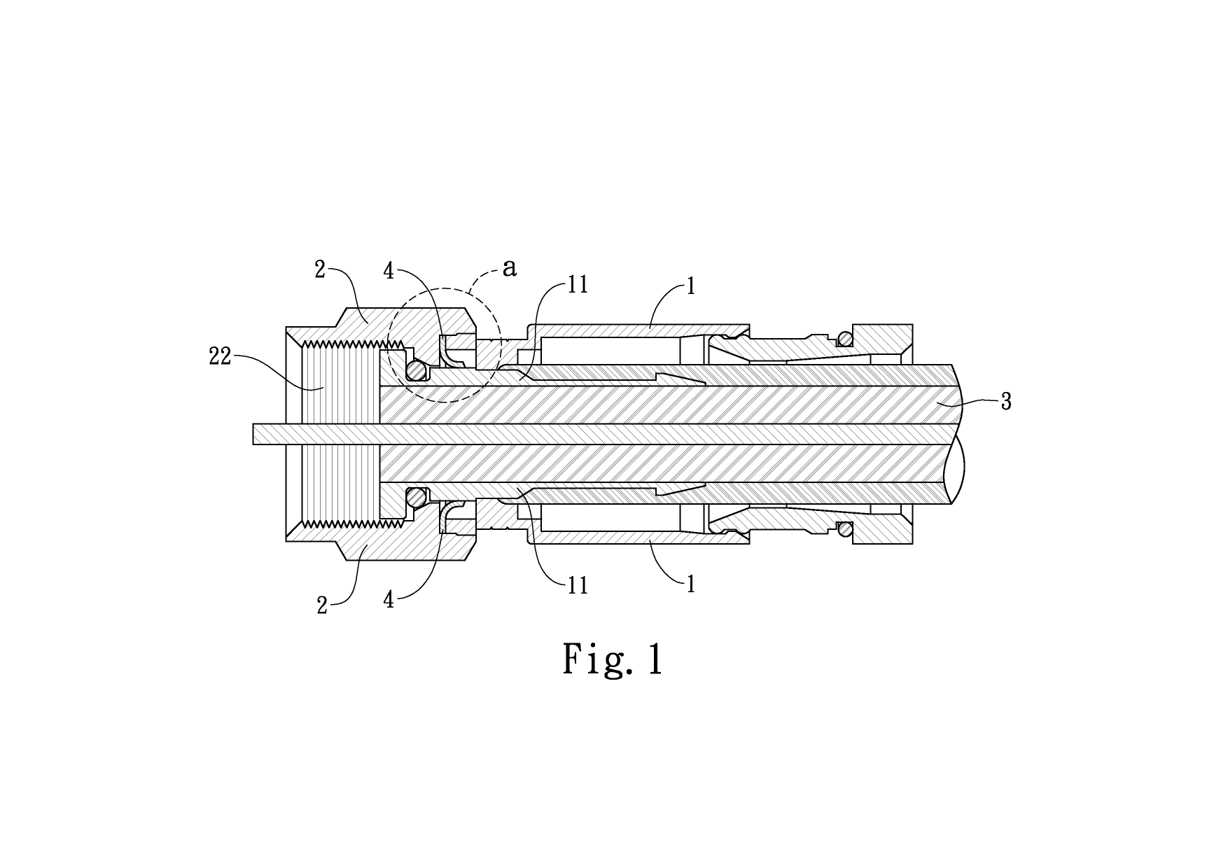

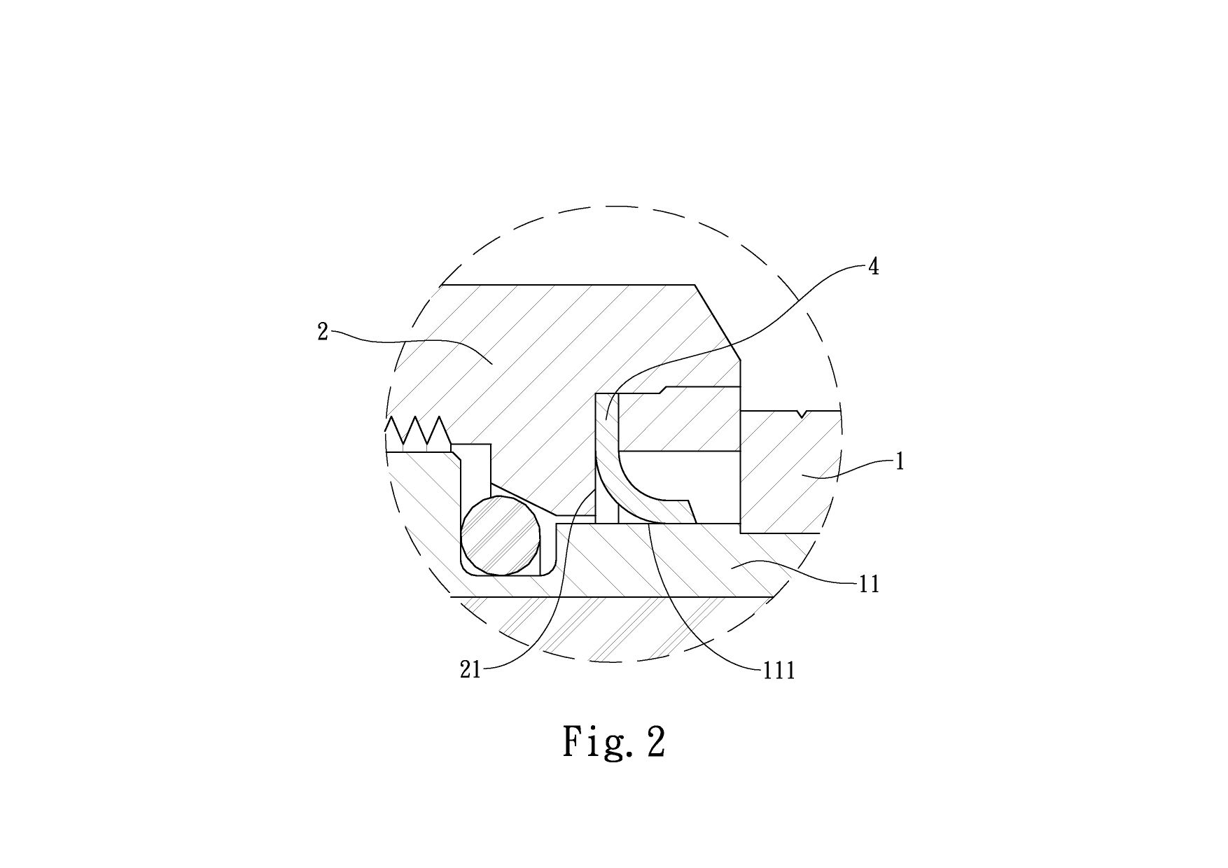

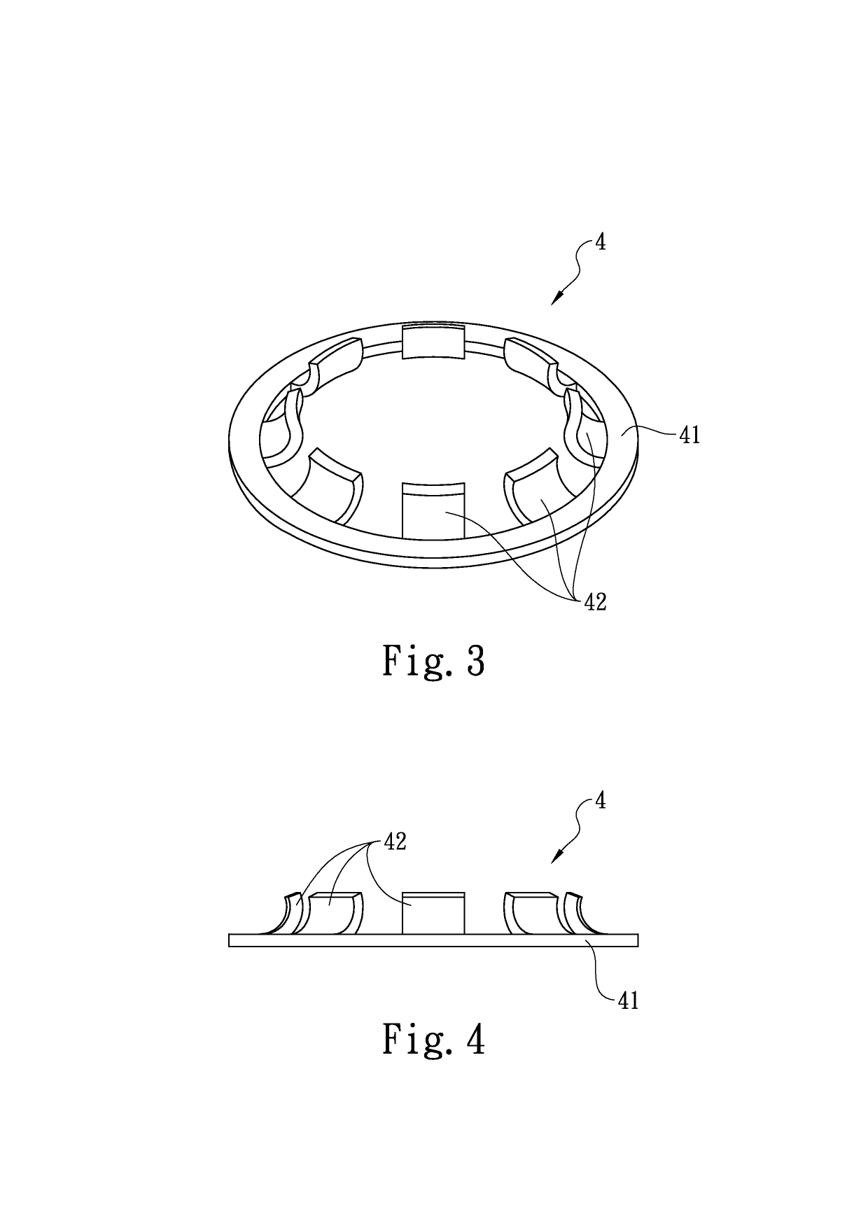

FIG. 1 to FIG. 4 show a first embodiment of a coaxial cable connector structure with contact continuity of the present invention, which includes a sleeve 1 and a ring-shaped screw cap 2 provided at a front end of the sleeve 1.

The sleeve 1 has an inner tube 11 provided therein for connecting a coaxial cable 3. An inner wall 21 of the ring-shaped screw cap 2 and an outer wall 111 of the inner tube 11 in the sleeve 1 have a ring-shaped conducting member 4 provided there-between, thereby forming electrical connection between the ring-shaped screw cap 2 and the inner tube 11.

The conducting member 4 is made of a conductive metal material, and includes a ring-shaped body 41. The ring-shaped body 41 is provided with a plurality of arc-shaped or non-arc-shaped contact pieces 42 (this embodiment takes the arc-shaped contact pieces as an example), and an inner surface of the ring-shaped screw cap 2 has an inner thread 22 for combining a connection socket with an outer thread.

Thereby, when the ring-shaped screw cap 2 is locked to the connection socket with the outer thread through the inner thread 22, the conducting member 4, provided between the inner wall 21 of the ring-shaped screw cap 2 and the outer wall 111 of the inner tube 11 in the sleeve 1, may effectively form electrical connection between the ring-shaped screw cap 2 and the inner tube 11, so as to effectively maintain signal transmission.

To sum up, according to the content disclosed above, the present invention can definitely achieve the expected objective and provide the coaxial cable connector structure with contact continuity, which is of great value in industrial utilization. Therefore, this patent application for a present invention is put forward according to the law.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A coaxial cable connector structure with contact continuity, comprising a sleeve and a ring-shaped screw cap provided at a front end of the sleeve, the sleeve having an inner tube provided therein for connecting a coaxial cable, characterized in that
a ring-shaped conducting member is disposed between an inner wall of the ring-shaped screw cap and an outer wall of the inner tube in the sleeve, thereby forming electrical connection between the ring-shaped screw cap and the inner tube.

2. The coaxial cable connector structure with contact continuity according to claim 1, wherein the conducting member comprises a ring-shaped body, and the ring-shaped body is provided with a plurality of arc-shaped contact pieces.

3. The coaxial cable connector structure with contact continuity according to claim 1, wherein the conducting member comprises a ring-shaped body, and the ring-shaped body is provided with a plurality of non-arc-shaped contact pieces.

4. The coaxial cable connector structure with contact continuity according to claim 1, wherein an inner surface of the ring-shaped screw cap has an inner thread for combining a connection socket with an outer thread.
